(19) United States
(12) Patent Application Publication
(10) Pub. No.: US 2011/0089135 A1
(43) Pub. Date: Apr. 21, 2011

(54) LASER MODIFIED PLASTIC CONTAINER

(76) Inventors: John B. SIMON, Springfield, MA (US); Kirk Edward MAKI, Tecumseh, MI (US)

(21) Appl. No.: 12/906,246

(22) Filed: Oct. 18, 2010

Related U.S. Application Data
(60) Provisional application No. 61/252,837, filed on Oct. 19, 2009.
(60) Provisional application No. 61/358,467, filed on Jun. 25, 2010.

(51) Int. Cl. B65D 90/02; B29C 35/08

(52) U.S. Cl. 215/379; 264/482; 264/400

(57) ABSTRACT

A polyethylene terephthalate container having a laser-formed area, wherein the laser-formed area is modified in response to radiation energy. In some embodiments, the laser-formed area of the container permitting localized contouring to permit or otherwise generally prevent flexural response to vacuum and/or loading forces. In some embodiments, the laser-formed area of the container comprises visible indicia formed to permit labeless containers.

### CROSS-REFERENCE TO RELATED APPLICATIONS

This application claims the benefit of U.S. Provisional Application No. 61/252,837, filed on Oct. 19, 2009, and U.S. Provisional Application No. 61/358,467, filed on Jun. 25, 2010. The entire disclosures of each of the above applications are incorporated herein by reference.

### FIELD

This disclosure generally relates to plastic containers for retaining a commodity, such as a solid or liquid commodity. More specifically, this disclosure relates to a polyethylene terephthalate (PET) container being shaped using a laser to modify flexural response to vacuum and/or loading forces, and/or being inscribed using a laser thereby eliminating the need for plastic, paper, or other material labels to be affixed to the container.

### BACKGROUND AND SUMMARY

This section provides background information related to the present disclosure which is not necessarily prior art. This section also provides a general summary of the disclosure, and is not a comprehensive disclosure of its full scope or all of its features.

As a result of environmental and other concerns, plastic containers, more specifically polyester and even more specifically polyethylene terephthalate (PET) containers are now being used more than ever to package numerous commodities previously supplied in glass containers. Manufacturers and fillers, as well as consumers, have recognized that PET containers are lightweight, inexpensive, recyclable and manufacturable in large quantities.

Blow-molded plastic containers have become commonplace in packaging numerous commodities. Studies have indicated that the configuration and overall aesthetic appearance of a blow-molded plastic container can affect consumer purchasing decisions. For example, a dented, distorted or otherwise unaesthetically pleasing container may provide the reason for some consumers to purchase a different brand of product which is packaged in a more aesthetically pleasing fashion.

While a container in its as-designed configuration may provide an appealing appearance when it is initially removed from a blow-molding machine, many forces act subsequently on, and alter, the as-designed shape from the time it is blow-molded to the time it is placed on a store shelf. Plastic containers are particularly susceptible to distortion since they are continually being re-designed in an effort to reduce the amount of plastic required to make the container. While this strategy realizes a savings with respect to material costs, the reduction in the amount of plastic can decrease container rigidity and structural integrity.

Manufacturers currently supply PET containers for various liquid commodities, such as juice and isotonic beverages. Suppliers often fill these liquid products into the containers while the liquid product is at an elevated temperature, typically between 155° F.-205° F. (68° C.-96° C.) and usually at approximately 185° F. (85° C.). When packaged in this manner, the hot temperature of the liquid commodity sterilizes the container at the time of filling. The bottling industry refers to this process as hot filling, and the containers designed to withstand the process as hot-fill or heat-set containers.

The hot filling process is acceptable for commodities having a high acid content, but not generally acceptable for non-high acid content commodities. Nonetheless, manufacturers and fillers of non-high acid content commodities desire to supply their commodities in PET containers as well.

For non-high acid content commodities, pasteurization and retort are the preferred sterilization processes. Pasteurization and retort both present an enormous challenge for manufactures of PET containers in that heat-set containers cannot withstand the temperature and time demands required of pasteurization and retort.

Pasteurization and retort are both processes for cooking or sterilizing the contents of a container after filling. Both processes include the heating of the contents of the container to a specified temperature, usually above approximately 155° F. (approximately 70° C.), for a specified length of time (20-60 minutes). Retort differs from pasteurization in that retort uses higher temperatures to sterilize the container and cook its contents. Retort also applies elevated air pressure externally to the container to counteract pressure inside the container. The pressure applied externally to the container is necessary because a hot water bath is often used and the overpressure keeps the water, as well as the liquid in the contents of the container, in liquid form, above their respective boiling point temperatures.

PET is a crystallizable polymer, meaning that it is available in an amorphous form or a semi-crystalline form. The ability of a PET container to maintain its material integrity relates to the percentage of the PET container in crystalline form, also known as the “crystallinity” of the PET container. The following equation defines the percentage of crystallinity as a volume fraction:

$$\% Crystallinity = ( \frac{ρ - {ρ}_{a}}{{ρ}_{c} - {ρ}_{a}} ) \times 100$$

where ρ is the density of the PET material; ρa is the density of pure amorphous PET material (1.333 g/cc); and ρc is the density of pure crystalline material (1.455 g/cc).

Container manufacturers use mechanical processing and thermal processing to increase the PET polymer crystallinity of a container. Mechanical processing involves orienting the amorphous material to achieve strain hardening. This processing commonly involves stretching a PET preform along a longitudinal axis and expanding the PET preform along a transverse or radial axis to form a PET container. The combination promotes what manufacturers define as biaxial orientation of the molecular structure in the container. Manufacturers of PET containers currently use mechanical processing to produce PET containers having approximately 20% crystallinity in the container's sidewall.

Thermal processing involves heating the material (either amorphous or semi-crystalline) to promote crystal growth. On amorphous material, thermal processing of PET material results in a spherulitic morphology that interferes with the transmission of light. In other words, the resulting crystalline material is opaque, and thus, generally undesirable. Used after mechanical processing, however, thermal processing results in higher crystallinity and excellent clarity for those portions of the container having biaxial molecular orientation. The thermal processing of an oriented PET container, which is known as heat setting, typically includes blow molding a PET preform against a mold heated to a temperature of approximately 250° F.-350° F. (approximately 121° C.-177° C.), and holding the blown container against the heated mold for approximately two (2) to five (5) seconds. Manufacturers of PET juice bottles, which must be hot-filled at approximately 185° F. (85° C.), currently use heat setting to produce PET bottles having an overall crystallinity in the range of approximately 25%-30%.

After being hot-filled, the heat-set containers are capped and allowed to reside at generally the filling temperature for approximately five (5) minutes at which point the container, along with the product, is then actively cooled prior to transferring to labeling, packaging, and shipping operations. The cooling reduces the volume of the liquid in the container. This product shrinkage phenomenon results in the creation of a vacuum within the container. Generally, vacuum pressures within the container range from 1-380 mm Hg less than atmospheric pressure (i.e., 759 mm Hg-380 mm Hg). If not controlled or otherwise accommodated, these vacuum pressures result in deformation of the container, which leads to either an aesthetically unacceptable container or one that is unstable. Hot-fillable plastic containers must provide sufficient flexure to compensate for the changes of pressure and temperature, while maintaining structural integrity and aesthetic appearance. Typically, the industry accommodates vacuum related pressures with sidewall structures or vacuum panels formed within the sidewall of the container. Such vacuum panels generally distort inwardly under vacuum pressures in a controlled manner to eliminate undesirable deformation.

While vacuum panels allow containers to withstand the rigors of a hot-fill procedure, the panels have limitations and drawbacks. First, vacuum panels formed within the sidewall of a container do not create a generally smooth glass-like appearance. Second, packagers often apply a wrap-around or sleeve label to the container over the vacuum panels. The appearance of these labels over the sidewall and vacuum panels is such that the label often becomes wrinkled and not smooth. Additionally, one grasping the container generally feels the vacuum panels beneath the label and often pushes the label into various panel crevasses and recesses.

These traditional containers were not easy for consumers to handle while carrying or dispensing product from the container. Further refinements have led to the use of pinch grip geometry in the sidewall of the containers to help control container distortion resulting from vacuum pressures. However, similar limitations and drawbacks exist with pinch grip geometry as with vacuum panels.

In many instances, container weight is correlated to the amount of the final vacuum present in the container after this fill, cap and cool down procedure, that is, the container is made relatively heavy to accommodate vacuum related forces. Similarly, reducing container weight, i.e., “lightweight” the container, while providing a significant cost savings from a material standpoint, requires a reduction in the amount of the final vacuum.

External forces are applied to sealed containers as they are packed and shipped. Filled containers are packed in bulk in cardboard boxes, or plastic wrap, or both. A bottom row of packed, filled containers may support several upper tiers of filled containers, and potentially, several upper boxes of filled containers. Therefore, it is important that the container have a top loading capability which is sufficient to prevent distortion from the intended container shape.

It is thus desirable to provide a container that includes features conducive to withstanding and/or absorbing vacuum or other loading forces without complex shapes that may be difficult to mold. Moreover, it is desirable to provide a container that can be simply formed that includes localized or discrete areas that encourage or discourage flexural response to vacuum or other loading forces.

According to the principles of the present teachings, a PET container can be provided having areas of localized contouring via a laser to permit or otherwise generally prevent flexural response to vacuum and/or loading forces.

Separately, and yet related, container manufacturers, in an attempt to market and identify their products to consumers, typically affix indicia to the container. This indicia typically includes such things as label art, logos, trademarks, and/or product information and is created on separate labels to be applied to the container during manufacturing and/or filling. These labels are typically in the form of plastic or paper sheets that surround the container and are affixed with adhesive or by shrink-wrapping.

However, it should be appreciated that there are a number of disadvantages of such conventional labels. By way of non-limiting example, convention labels must obviously be manufactured separate from the container and thus add expense and complexity to the manufacturing process. The fact that convention labels often contain elaborate artwork can lead to considerable expense and downtime when printing machines must be reconfigured for changes to such artworks. Furthermore, conventional labels are often made of material that is different than that of the container and, thus, must be separated from and processed differently during recycling. This added recycling complexity can lead to reduced recycling profitability and increased landfill waste.

Therefore, it is also desirable to provide a container that is able to overcome the disadvantages of manufacturing, cost, and complexity of conventional label systems. To achieve this, in some embodiments, a labeless container is provided that comprises a container body having a laser etched label system that is formed directly into the container material, thereby eliminating the need for a separately manufactured label, decreasing manufacturing costs, and increasing flexibility in varying artwork and indicia.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of an exemplary container incorporating the features of the present teachings;

FIG. 2 is a photographic image of a container having a plurality of voids laser formed therein;

FIG. 3 is an enlarged photographic image of a container having a plurality of voids laser formed therein;

FIG. 4 is a photographic image of a container having a plurality of depressions laser formed therein;

FIG. 5 is an enlarged photographic image of a container having a plurality of depressions laser formed therein;

FIG. 6 is a photographic image of a container having an area of raised heated material;

FIG. 7 is an enlarged photographic image of a container having an area of raised heated material;

FIGS. 8A-8H is a series of alternative embodiments according to the principles of the present teachings; and

FIG. 9 is a photograph of a container according to the principles of the present teachings.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### Laser Contoured Force Response

As discussed above, to accommodate vacuum related forces during cooling of the contents within a PET heat-set container, containers typically have a series of vacuum panels or pinch grips around their sidewall, and/or flexible grip areas. The vacuum panels, pinch grips and flexible grip areas all deform inwardly, to some extent, under the influence of vacuum related forces and prevent unwanted distortion elsewhere in the container. These vacuum panels, pinch grips, and flexible grip areas, or other areas throughout the container, can be tailor to have weakened or strengthened areas for improved accommodation of internal vacuum forces. As will be discussed herein, this can be achieved through the use of localized laser energy in the container to vary the structural characteristics of the container material.

In a PET heat-set container, a combination of controlled deformation and vacuum resistance is required. The present teachings provide for a plastic container which enables its flexural regions to be tailor to define a varied response to internal and external forces—namely a weakened or strengthened response to achieve a desired and predictable flexural response to forces and loads. This improved construction of the remaining portions of the plastic container is able to accommodate additional forces and loads through structural and material response.

It should be appreciated that the size and specific configuration of the container may not be particularly limiting and, thus, the principles of the present teachings can be applicable to a wide variety of PET container shapes. Therefore, it should be recognized that variations can exist in the present embodiments. That is, it should be appreciated that the teachings of the present disclosure can be used in a wide variety of containers, including reusable/disposable packages.

Accordingly, the present teachings provide a plastic, e.g. polyethylene terephthalate (PET), container generally indicated at 10. The exemplary container 10 can be substantially elongated when viewed from a side. Those of ordinary skill in the art would appreciate that the following teachings of the present disclosure are applicable to other containers, such as rectangular, triangular, pentagonal, hexagonal, octagonal, polygonal, or square shaped containers, which may have different dimensions and volume capacities. It is also contemplated that other modifications can be made depending on the specific application and environmental requirements.

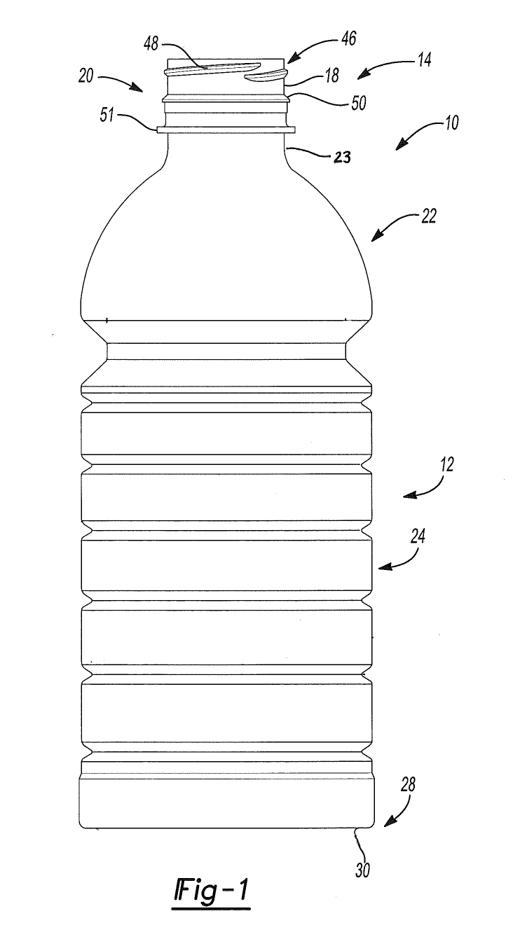

As shown in FIG. 1, the exemplary plastic container 10 according to the present teachings defines a body 12, and includes an upper portion 14 having a cylindrical sidewall 18 forming a finish 20. Integrally formed with the finish 20 and extending downward therefrom is a shoulder portion 22. The shoulder portion 22 merges into and provides a transition between the finish 20 and a sidewall portion 24. The sidewall portion 24 extends downward from the shoulder portion 22 to a base portion 28 having a base 30. In some embodiments, sidewall portion 24 can extend down and nearly abut base 30, thereby minimizing the overall area of base portion 28 such that there is not a discernable base portion 28 when exemplary container 10 is uprightly-placed on a surface.

The exemplary container 10 may also have a neck 23. The neck 23 may have an extremely short height, that is, becoming a short extension from the finish 20, or an elongated height, extending between the finish 20 and the shoulder portion 22. The upper portion 14 can define an opening for filling and dispensing of a commodity stored therein. Although the container is shown as a drinking container, it should be appreciated that containers having different shapes, such as sidewalls and openings, can be made according to the principles of the present teachings.

The finish 20 of the exemplary plastic container 10 may include a threaded region 46 having threads 48, a lower sealing ridge 50, and a support ring 51. The threaded region provides a means for attachment of a similarly threaded closure or cap (not illustrated). Alternatives may include other suitable devices that engage the finish 20 of the exemplary plastic container 10, such as a press-fit or snap-fit cap for example. Accordingly, the closure or cap (not illustrated) engages the finish 20 to preferably provide a hermetical seal of the exemplary plastic container 10. The closure or cap (not illustrated) is preferably of a plastic or metal material conventional to the closure industry and suitable for subsequent thermal processing.

The plastic container 10 of the present invention is a blow molded, biaxially oriented container with an unitary construction from a single or multi-layer material. A well-known stretch-molding, heat-setting process for making the hot-fillable plastic container 10 generally involves the manufacture of a preform (not illustrated) of a polyester material, such as polyethylene terephthalate (PET), having a shape well known to those skilled in the art similar to a test-tube with a generally cylindrical cross section and a length typically approximately fifty percent (50%) that of the container height. A machine (not illustrated) places the preform heated to a temperature between approximately 190° F. to 250° F. (approximately 88° C. to 121° C.) into a mold cavity (not illustrated) having a shape similar to the plastic container 10. The mold cavity is heated to a temperature between approximately 250° F. to 350° F. (approximately 121° C. to 177° C.). A stretch rod apparatus (not illustrated) stretches or extends the heated preform within the mold cavity to a length approximately that of the container thereby molecularly orienting the polyester material in an axial direction generally corresponding with a central longitudinal axis of the container 10. While the stretch rod extends the preform, air having a pressure between 300 PSI to 600 PSI (2.07 MPa to 4.14 MPa) assists in extending the preform in the axial direction and in expanding the preform in a circumferential or hoop direction thereby substantially conforming the polyester material to the shape of the mold cavity and further molecularly orienting the polyester material in a direction generally perpendicular to the axial direction, thus establishing the biaxial molecular orientation of the polyester material in most of the container. Typically, material within the finish 12 and a sub-portion of the base 20 are not substantially molecularly oriented. The pressurized air holds the mostly biaxial molecularly oriented polyester material against the mold cavity for a period of approximately two (2) to five (5) seconds before removal of the container from the mold cavity. The plastic container 10 can be heat-set according to the above-mentioned process or other conventional heat-set processes.

Alternatively, other manufacturing methods using other conventional materials including, for example, polyethylene naphthalate (PEN), a PET/PEN blend or copolymer, and various multilayer structures may be suitable for the manufacture of plastic container 10. Those having ordinary skill in the art will readily know and understand plastic container manufacturing method alternatives.

To accommodate vacuum forces, the container of the present teachings employs a novel and innovative construction.

In some embodiments, the container can comprise vacuum panels of the container 10 include an underlying surface, a wall thickness, a series of ribs and a perimeter wall or edge. In the preferred embodiment, ribs are generally arcuately shaped, arranged horizontally or vertically, and generally spaced equidistantly apart from one another.

In conventional applications, the wall thickness of the vacuum panels must be thin enough to allow vacuum panels to be flexible and function properly. However, according to the present teachings, this may not be absolutely necessary.

The present teachings employ a laser to output radiation energy in the form of a conventional laser beam. The laser beam can be directed to discrete locations on the container and used to mechanically alter the material, material integrity, or other properties of the container to achieve the desired weakening or strengthening of the localized portion of the container. To this end, the laser can be directed at an intended location on the container and can be actuated to melt or deform the container to define stiffened/weakened sections, create deformation patterns, or otherwise vary the load response of the material and/or container.

In some embodiments, it has been found that by using the laser of the present teachings, controlled areas of deformation can be used in place of vacuum panels or other features that are conventionally used to accommodate container forces.

According to the present teachings, several desired affects can be created using laser energy to weaken or strengthen an area of the container 10. That is, to achieve a weakened area, the strength of a planar area can be changed by making modifications to that area which allow stresses to act upon it differently. Generally, a plane achieves its strength from its uniformity or its shape if the plane is wrapped into a cylinder. Adding areas of different material stress, material thickness, or different material properties can influence the way the cylinder or geometric article performs. Many geometric patterns can be influenced by precisely locating areas of weaker (i.e.—lower modulus or stiffness) material properties. In the cases of a vacuum, the internal forces pulling evenly on the inside of the container will cause the weakened area to collapse first or deform in a predictable/controllable manner. That is, a cylinder can be caused to collapse in the center sooner by creating a line of imperfections parallel to the cylinder ends and moving around the container horizontally. Imperfections in a geometric pattern or plane can not only cause it to collapse first, but also directionally deform the container. Deformation can be created that will follow the imperfections created in the surface of a geometric article. Therefore, if a line of horizontal imperfections is created and a line of imperfections that extends away at an angle to the horizontal line, the deformation will follow the imperfections transversely across the panel. A container can be created such that by weakening specific areas, the container can be made stronger by confining the area of deformation.

In some embodiments, the deformation can be achieved through the vaporization of the material or the melting of multiple spots in a relatively high density of area. In this way, the material thickness and integrity can be reduced, thereby encouraging localized deformation. Therefore, by creating imperfections in the vacuum panel of a bottle, the panel can be flexed more easily under a lower vacuum. It can create an easier moving vacuum panel that can absorb more vacuum before distorting the area around the panel. Geometric patterns can also be created in the panel itself, allowing it to flex and move in ways not possible to blow mold. This flexing pattern can more easily and effectively relieve internal pressures. It is generally understood that the more outward the geometric shape of a vacuum panel, the more vacuum that panel can absorb. However, the more outward (i.e. convex) the geometric shape of the vacuum panel, the more vacuum or force is required to flex them to maximize the absorption. According to the present teachings, these panels can be “weakened” to allow easier flexing at lower forces, but still provide sufficient maximum vacuum accommodation at higher forces.

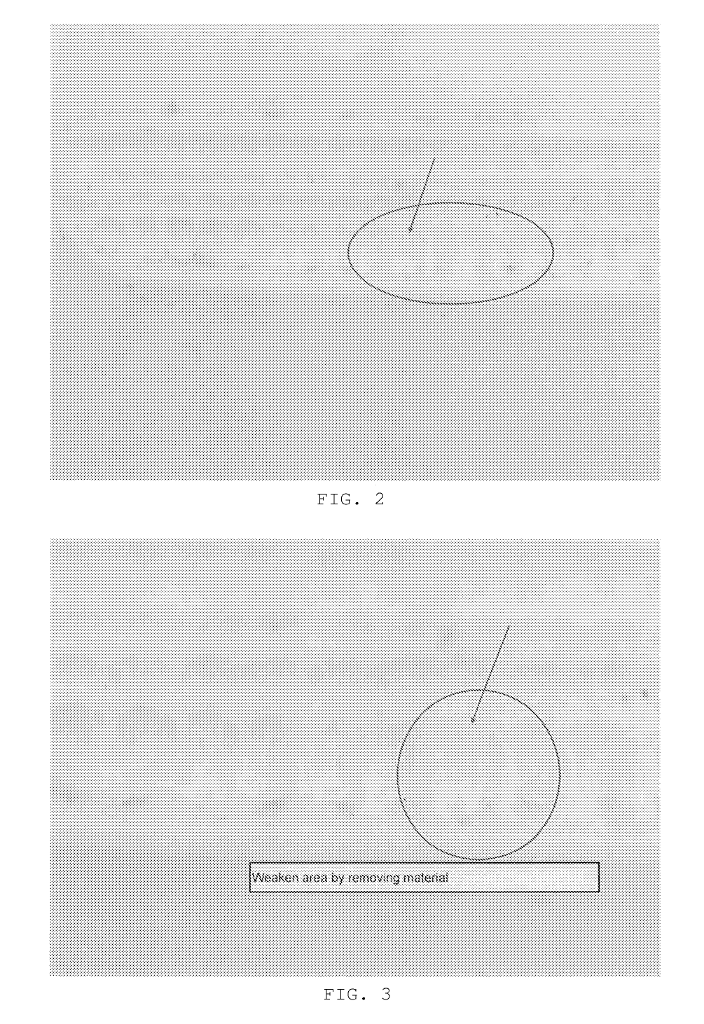

With reference to FIGS. 2-5, it can be seen that container 10 can comprise a plurality of depressions or reliefs formed in the material thereof. These depressions can serve to weaken or otherwise facilitate localized bending or flexing of container 10. In some embodiments, these depressions can be patterned to provide a contoured response in response to forces and, in particular, can provide a contoured response when the force is directed in a first direction and a different response when the force is directed in a second direction. In some embodiments, such patterning of depressions can be used to promote initial flexure during vacuum response. This flexure can be used to formed a final desired container shape and/or promote container body contouring in an areas that is less likely to be seen or felt by a consumer.

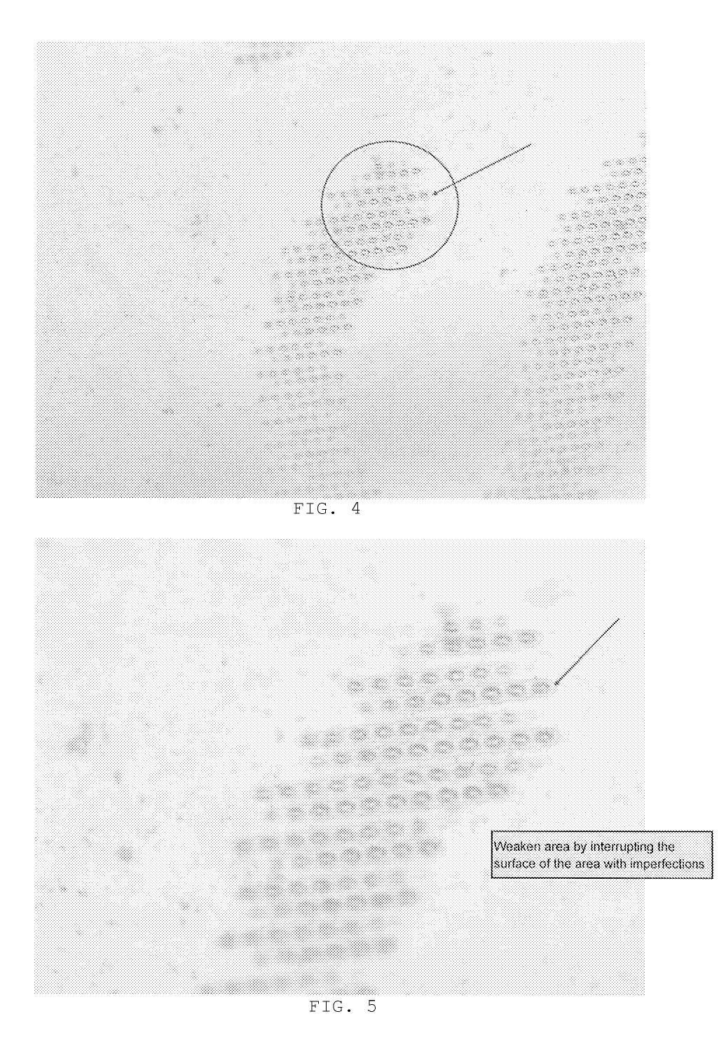

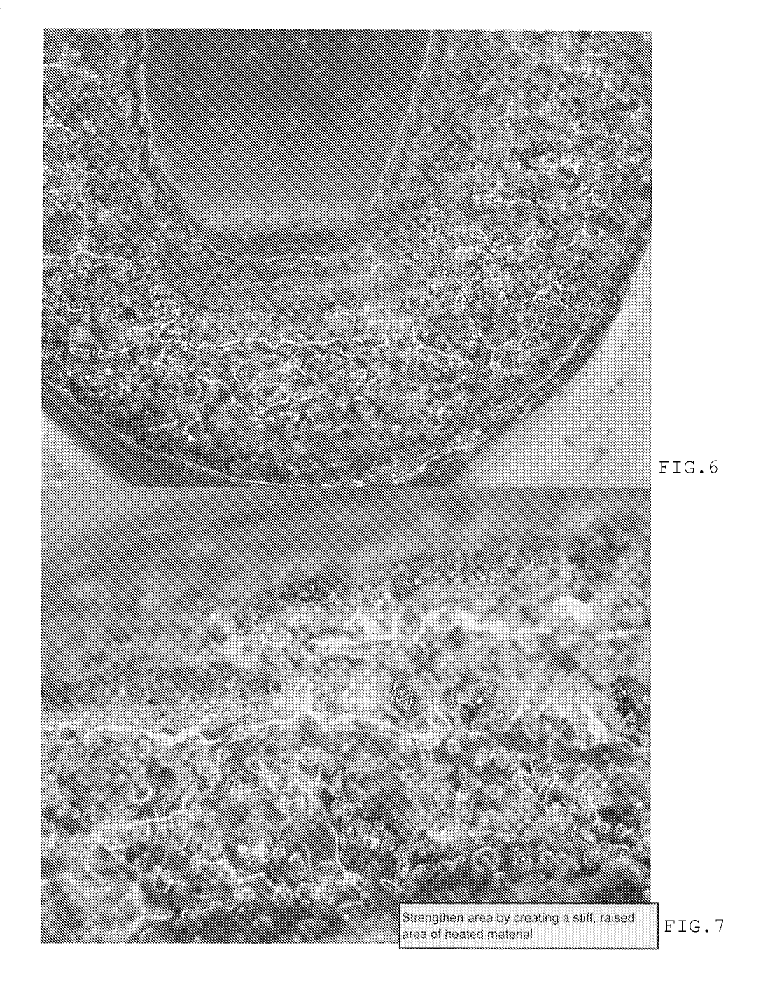

Still referring to FIGS. 5-7, it can be seen that container 10 can comprise an area of raised material caused through the heating of the container in a localized area. The raised material and subsequent cooling effect in this localized area can serve to strengthen the localized area, which in turn can inhibit flexural response of the container when exposed to force. The heating of this area can, in some embodiments, change the crystalline structure of the material and, thus, modify the plastic deformation properties of the material. In some embodiments, the raised material of the container can further provide improved aesthetic features or functions.

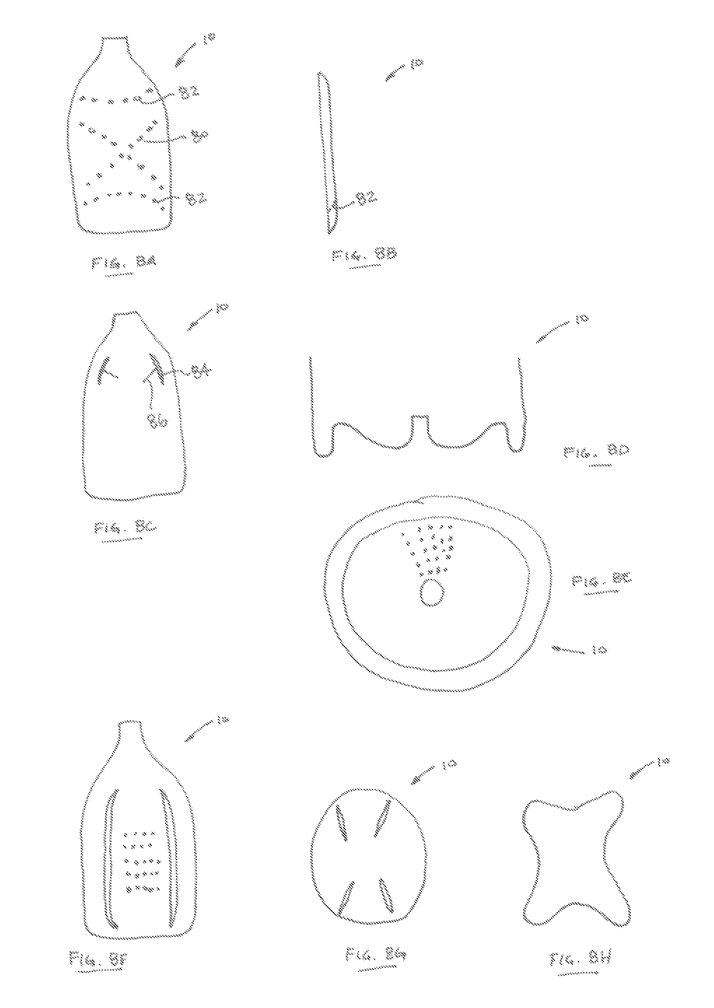

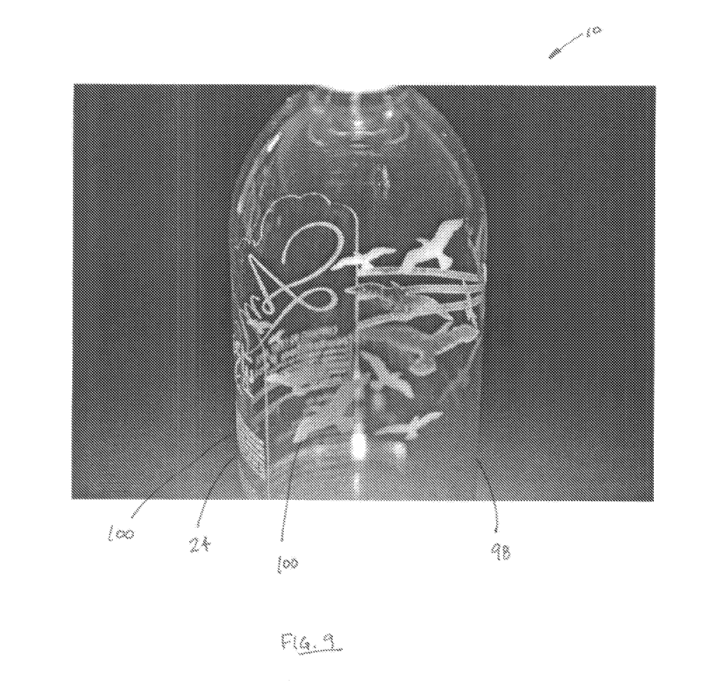

It should be appreciated that the aforementioned laser modification of container 10 can be done in any area of container 10 where a desired response to application of force is desired. For example, as illustrated in FIGS. 8A-8H, laser modification of container 10 can include both strengthened, weakened, other otherwise modified discrete areas. In some embodiments, as illustrated in FIGS. 8A and 8B, container 10 can include strengthened areas 80 and weakened areas 82. These areas can be formed as small circular portions, lines, sections, or other shapes. In some embodiments, as illustrated in FIG. 8C, container 10 can include a strengthened or stiffened area 84 intersecting a weakened or creased area 86. It should be recognized that weakened area 86 could be alternatively stiffened to prevent creasing or the like.

With particular reference to FIGS. 8D and 8E, the cross-section of container 10 (FIG. 8D) and the bottom view (FIG. 8E) illustrate targeted weakened area 82 being disposed along an underside, base, or push-up area of the container to encourage flexural response therein in response to vacuum forces.

As seen in FIGS. 8F-8H, container 10 can include strengthened strips 88 extending longitudinally that can be used to stiffen the longitudinal direction of the container 10 and further include weakened area 90 acting as a vacuum panel for vacuum absorption. Under vacuum force, as seen in FIG. 8H, container 10 can flex in response to these modified areas.

Upon filling, capping, sealing and cooling, the perimeter wall or edge acts as a hinge that aids in the allowance of the underlying surface of vacuum panels to be pulled radially inward, toward the central longitudinal axis of the container 10, displacing volume, as a result of vacuum forces. The hinge action is facilitated by the placement of the depressions via a laser source and generally inhibited by the placement of the raised areas of material via the laser source.

The unique construction of the container of the present teachings provides added structure, support and strength to the container 10. This added structure, support and strength, due to the use of the lasered contours enhances the top load strength capabilities of the container 10 by aiding in transferring top load forces, thereby preventing creasing, bulking, denting and deforming of the container 10 when subjected to top load forces. Furthermore, this added structure, support and strength, resulting from the unique construction of the container, minimizes the outward movement, bowing and sagging of the sidewall portion during fill, seal and cool down procedure.

As discussed, one of the significant benefits of the present invention is the reduction of vacuum pressure. Due to this reduced vacuum pressure that the container is subjected to, the container can be formed of less material and thus achieve a lighter configuration. This can lead to reduced material consumption and cost.

### Laser Contoured Indicia

The sidewall portion 24 of container 10 can be formed to define a generally smooth surface 98 or, in some embodiments, can comprise various features that provide added structural integrity and/or aesthetic impact. It should be understood that the principles of the present teachings are equally applicable to uniform and non-uniform surfaces. Therefore, in some embodiments, sidewall portion 24 or other portions of container 10 can comprise laser-formed indicia 100.

In some embodiments, laser-formed indicia 100 is a laser engraved indicia, such as label art, logos, trademarks, product information, and the like, or texture that is formed within the material (e.g. sidewall portion 24) of container 10. Although variations exist, laser-formed indicia 100 can be formed using a Helix 45W CO2 laser into the PET material of container 10. During testing, it was found that a focal length of two inches (2″), a raster speed of 70%, a raster power of 13%, and a resolution of 400 DPI can produce laser-formed indicia 100 having suitable contrast, depth, and appearance.

It should also be appreciated that in some embodiments the laser can be used to form indicia 100 in a coating or other material applied to the exterior of container 10. In this way, various color and/or display effects can be created in the indicia 100. It should also be understood that absent such a coating or other material, colored indicia can be created depending on laser type and usage.

In some embodiments, the laser can be use to create indicia 100 upon an internal surface of sidewall portion 24 of container 10. In the regard, the laser can be disposed or otherwise configured to create indicia 100 on the internal surface of container 10, thereby resulting in a smooth exterior surface and indicia 100 being seen through the sidewall portion 24 of container 10.

Depending upon the laser type, intensity, and duration used in creating indicia 100, variation can exist in the resulting physical structure of indicia 100 and the associate surrounding material of container 10. Specifically, depending on laser type, intensity, and duration, indicia 100 can be formed by varying the crystalline structure of the PET material of container 10. In this regard, the wall thickness of container 10 can be substantially unchanged compared to that prior to formation of indicia 100. Alternatively, depending on laser type, intensity, and duration, indicia 100 can be formed via laser etching, thereby removing a portion of the wall thickness material of sidewall portion 24. Although variations exist, they are believed to be within the scope of the present teachings unless otherwise specifically excluded.

Therefore, according to the present teachings, indicia, such as label art, logos, trademarks, product information, and the like, can be formed in a plastic container, both inside and outside of the container, using a laser. In doing so, plastic or paper labels can be eliminated, thereby eliminating the need for a separately manufactured label, decreasing manufacturing costs, and increasing flexibility in varying artwork and indicia. Moreover, the present teachings provide a means to reduce landfill waste (i.e. unrecyclable labels) and simplifies the recycling process for the present container.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A container comprising:
a neck,
a shoulder portion extending from said neck,
a base portion, and
a sidewall portion interconnecting said shoulder portion and said base portion to form a volume for receiving a commodity,
at least one of said neck, shoulder, base portion, and said sidewall portion having a laser-formed area, said laser-formed area being modified in response to radiation energy.

2. The container according to claim 1 wherein said laser-formed area is materially weakened by said radiation energy to promote flexure in response to forces.

3. The container according to claim 1 wherein said laser-formed area is materially strengthened by said radiation energy to inhibit flexure in response to forces.

4. The container according to claim 1 wherein said laser-formed area is materially modified by said radiation energy.

5. The container according to claim 1 wherein said laser-formed area comprises a plurality of depressions or voids.

6. The container according to claim 1 wherein said laser-formed area comprises a visible indicia formed by said radiation energy.

7. The container according to claim 6 wherein said visible indicia is chosen from the group consisting of label art, logos, trademarks, and product information.

8. The container according to claim 1 wherein said laser-formed area comprises a surface texture formed by said radiation energy.

9. The container according to claim 1 wherein said laser-formed area is disposed within said volume.

10. A method for modifying a plastic container comprising:
providing a plastic container; and
applying radiation energy using a laser at a discrete area of said plastic container to modify the material characteristics of the discrete area in response to said radiation energy.

11. The method according to claim 10 wherein said applying radiation energy using a laser at a discrete area of said container comprises applying radiation energy using a laser to ablate material of said container.

12. The method according to claim 10 wherein said applying radiation energy using a laser at a discrete area of said container comprises applying radiation energy using a laser to strengthen material of said container through heating.

13. The method according to claim 10 wherein said applying radiation energy using a laser at a discrete area of said container comprises applying radiation energy using a laser to weaken material of said container.

14. The method according to claim 10 wherein said applying radiation energy using a laser at a discrete area of said container comprises applying radiation energy using a laser to generally inhibit flexure of said container.

15. The method according to claim 10 wherein said applying radiation energy using a laser at a discrete area of said container comprises applying
